(19) United States
(12) Patent Application Publication
(10) Pub. No.: US 2020/0042949 A1
(43) Pub. Date: Feb. 6, 2020

(54) AUTOMATED CALENDAR EVENT ASSOCIATION VIA IMPLICIT TAGGING

(71) Applicant: Microsoft Technology Licensing, LLC, Redmond, WA (US)

(72) Inventors: Warren David Johnson, III, Sammamish, WA (US); Charles Yin-Che Lee, Mercer Island, WA (US)

(21) Appl. No.: 16/054,759

(22) Filed: Aug. 3, 2018

(51) Int. Cl. G06Q 10/10

(52) U.S. Cl. CPC G06Q 10/1095; G06Q 10/1097

(57) ABSTRACT

In non-limiting examples of the present disclosure, systems, methods and devices for assisting with related calendar events are presented. One or more signals associated with a plurality of calendar events may be analyzed. A determination may be made as to whether, based on the analysis, the plurality of calendar events are related. The plurality of calendar events may be linked into a searchable entity with grouped properties. A search that indicates at least one of the grouped properties may be received, and information associated with the searchable entity may be caused to be displayed. In some examples, a digital assistant may automatically schedule a next event in a linked chain of events. In additional examples, an event scheduling service may utilize data from linked events to generate event metrics associated with task completion.

### BACKGROUND

Electronic calendars have become ubiquitous in everyday work and home life. Users are able to coordinate their own schedules using electronic calendars, and with internet connectivity, they are able to interact with other users' calendars via the sending and receiving of electronic calendar event invitations. Although electronic calendars have made keeping track of events and schedules a much easier task than was previously possible, creating new events in those calendars and identifying content from similar calendar events that would be useful in creation of those new events, can still be an arduous task, especially at the enterprise level.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for automatically linking calendar events, and utilizing properties of those linked calendar events to assist users with future event scheduling and time management. An event scheduling service and/or a digital assistant service may identify various signals associated with calendar events and determine based on that analysis that certain groups of calendar events are associated with one another and that they should be linked or otherwise electronically associated. In some examples, the signals may be processed by one or more machine learning models for determining whether the calendar events are associated with one another and/or whether they should be linked. In other examples, the signals may be associated with values, which in some cases may be weighted, and a determination of associated event relationships may be determined based on those values and/or weights. Examples of signals that may be indicative of calendar events be associated with one another include: the same or similar event times; the same or similar event dates; the same or similar invitees; the same or similar event invite subject lines; the same or similar event invite subject lines; and/or other signals described herein.

In some examples, linked events may be categorized into one or more searchable indices. The linked indices may be searchable by keyword or phrases associated with words or phrases in corresponding event invitations and/or scheduled events. The linked indices may additionally or alternatively be searchable based on topographical categories that linked calendar events have been categorized in. According to additional examples, an event scheduling service and/or digital assistant service may generate metrics associated with one or more linked calendar events (e.g., how many meeting hours in a linked calendar event chain were required to accomplish project A, which required a plurality of meetings to complete; how many users/persons were present in linked calendar event chain meetings associated with accomplishing project B, which required a plurality of meetings to complete). In other examples, an event scheduling service and/or digital assistant service may provide comparative analysis associated with similar linked calendar events.

### BRIEF DESCRIPTION OF THE DRAWINGS

Non-limiting and non-exhaustive examples are described with reference to the following figures:

FIG. 1 is a schematic diagram illustrating an example distributed computing environment for automatically associating calendar events that have common properties.

FIG. 2 illustrates the handling of a tag query that references at set of calendar events that have been automatically associated.

FIG. 3 illustrates a digital assistant utilizing information from a set of automatically associated calendar events to send out a calendar invite for the next event in the set.

FIG. 4 illustrates exemplary user interface elements for interacting with metrics generated from automatically linked calendar events.

FIG. 5 is an exemplary method for assisting with related calendar events.

FIGS. 6 and 7 are simplified diagrams of a mobile computing device with which aspects of the disclosure may be practiced.

FIG. 8 is a block diagram illustrating example physical components of a computing device with which aspects of the disclosure may be practiced.

FIG. 9 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments and examples described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the claims.

Examples of the disclosure provide systems, methods, and devices for automatically associating/linking calendar events that have common properties and utilizing that association for generating metrics and telemetry which can be beneficial to users in managing their time and resources. Additional aspects described herein utilize the information from the linking of calendar events to provide enhanced digital assistant scheduling services, including automatically sending out event invitations based on information associated with previous events in a linked set.

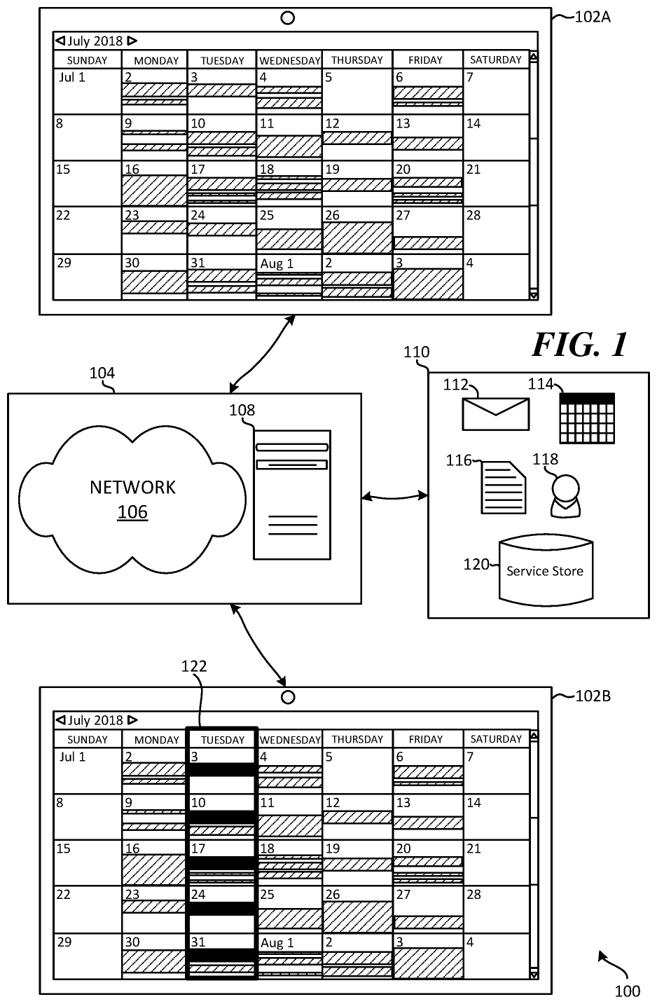

FIG. 1 is a schematic diagram illustrating an example distributed computing environment 100 for automatically associating calendar events that have common properties. Computing environment 100 comprises computing devices 102A and 102B, which may be the same or different computing devices. Computing environment 100 also comprises network and processing sub-environment 104, which may comprise an event scheduling service, and event scheduling store sub-environment 110. Network and processing sub-environment 104 includes network 106, via which any of the computing devices described herein may communicate with one another, and server computing device 108, which may perform operations associated with an event scheduling service operating thereon. Even scheduling store sub-environment 110 comprises service store 120, which contains information associated with a plurality of users' electronic calendar/scheduling applications, including document attachments 116 to event invitations, user information 118, past, present, and future calendar events 114, and invitations associated with past, present, and future events 112. Server computing device 108 and the event scheduling service may communicate with service store 120 and obtain and analyze information included therein in performing one or more operations described herein.

Computing device 102A is displaying a user's electronic calendar/scheduling application, which includes a plurality of calendar events associated with that user. The plurality of calendar events are indicated on the display of computing device 102A by the blocks filled in with a diagonal line pattern. One or more computing devices associated with the event scheduling service (e.g., server computing device 108) may determine whether one or more calendar events associated with the user's electronic calendar should be associated/linked with one another based on one or more signals in service store 120. In some examples, the event scheduling service and/or a digital assistant (e.g., Cortana, Siri, Alexa) associated with the event scheduling service, may determine that calendar events should be associated with one another if, for example, those calendar events are associated with the same or similar subject matter (e.g., monthly progress report meetings, employee candidate hiring meetings, etc.), or if the calendar events are derived from email threads that have common ancestry (e.g., emails stamped with a common thread ID). In some examples, the event scheduling service and/or digital assistant may determine that calendar events should be associated with one another based on analyzing one or more signals in service store 120, comprising event information indicating: events that have the same or similar invitees/attendees, events that are scheduled for the same or similar times, events that are scheduled for the same or similar days of the week, events that have the same or similar durations, event invitations that have the same or similar attachments, event invitations that have the same or similar content in their subject lines, events that are scheduled to be held in the same or similar location, events that have the same or similar communication type (e.g., telephone, video conference), and/or event invitations that have the same or similar content in their bodies.

In some examples, one or more machine learning models may be applied to one or more of the above-described signals to determine whether events should be linked. The machine learning models may be trained with user interaction (e.g., users may verify that the event scheduling service has appropriately linked events and/or inappropriately linked events). For example, if a first machine learning model has been applied to a plurality of events that are then linked by the event scheduling service, but users have manually indicated that those links were inappropriately created, that machine learning model may be indicated as not performing well, and thus it may be modified or applied to other event types. In another example, if a second machine learning model has been applied to a plurality of events that are then linked by the event scheduling service, and users have manually indicated that those links have been appropriately created, that machine learning model may be indicated as performing sufficiently, and it may be applied more frequently and/or to similar types of event data. In additional examples, users may indicate that one or more events in their electronic calendar should be associated with one another, and machine learning models may be trained to recognize appropriate events to associate with one another based on that past user input. In other examples, each of the analyzed signals may be assigned a value, and determinations may be made as to whether one or more calendar events should be associated based on values of the signals. In additional examples, the values may be weighted (e.g., more weight may be assigned to “important” signals and less weight may be assigned to less “important” signals). In some examples, the relative importance of each signal may be determined via application of one or more machine learning models. In other examples, the relative importance of each signal may be manually assigned.

Once a determination has been made that one or more events should be linked, the event scheduling service and/or a digital assistant associated with the event scheduling service may tag the one or more events as being associated with one another. The tag may comprise indicia of one or more topical categories in which the event scheduling service has determined the one or more events belong to based on their one or more associated signals. In some examples, the tag may be included in one or more searchable indices. The tag may be searchable, such that the event scheduling service, a digital assistant, and/or a user, may query the event scheduling service with keywords or phrases indicative of the tag, and identify linked calendar events corresponding to the tag. For example, if a user provides a tag query to the event scheduling service of “hiring”, the event scheduling service may return information associated with one or more linked events related to the hiring of individuals associated with the querying user or the querying user's enterprise. In another example, if a user provides a tag query to the event scheduling service of “project A”, the event scheduling service may return information associated one or more linked events related to “project A”. In other examples, natural language understanding may be applied to user queries such that the event scheduling service may recognize that queries match one or more categorized event linkages, despite the queries and/or the content of the linked events not directly matching. For example, a user may query the service with the keyword “call” and the service may surface linked events related to sales phone calls because phone numbers and sales content may have been included in one or more of the linked events and/or their subsequent categorization.

Linking and tagging events allows another system (e.g., a user query system, a digital assistant service), whether visual or conversational, to query and return a set of event requests that are determined to be related by their implicit tags either in isolation or in combination with one another. For example, if there is a project code names ‘Moneypenny” within an organization, and event information related to the development and delivery of the project are requested through a digital assistant/virtual scheduling assistant, the organizational leader may query the system and review all events/meetings that have taken place as related to the Moneypenny project and aggregate data such as who has attended meetings related to Moneypenny, total number of meeting hours, and the time range when those meetings took place.

In the example shown in FIG. 1, the event scheduling service has determined that five events during the month of July should be linked based on one or more event signals. Those events are indicated in the filled-in blocks shown at chunk 122 in the displayed event user interface on computing device 102B. The linked events were scheduled for a same time of the day, a same day of the week (Tuesday), and are of the same duration. Those three event signals and/or one or more additional event signals (e.g., event invitees, event invitation content, event titles) may have been processed through one or more machine learning models through which a determination was made that the meetings should be linked and tagged as being related to one another.

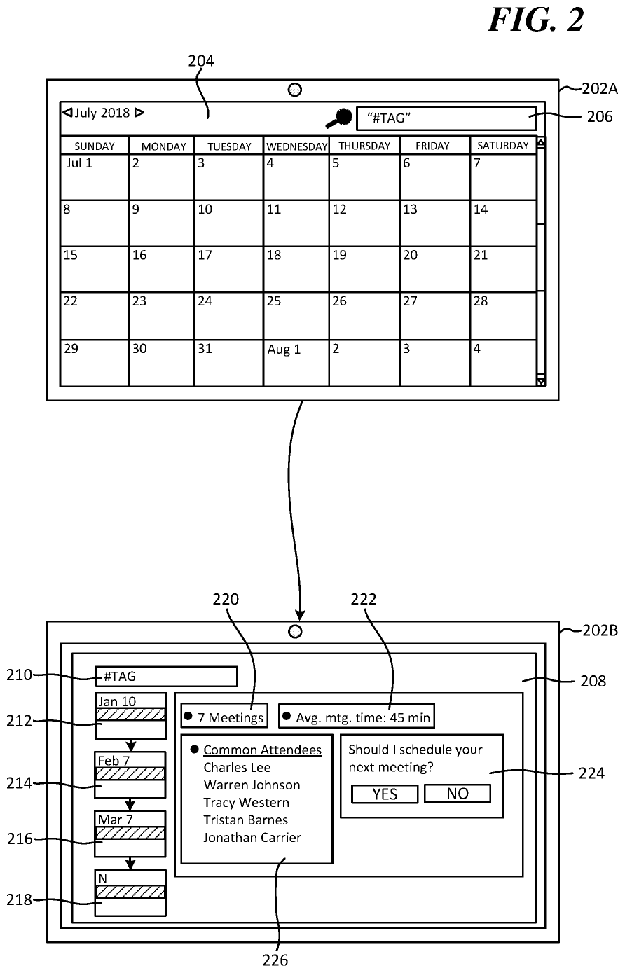

FIG. 2 illustrates the handling of a tag/associated event query that references a set of calendar events that have been automatically associated. In this example, a user of computing device 202A has input a tag query (# TAG) into tag query user interface element 206 in an event scheduling application user interface 204. The event scheduling application may be in communication with an event scheduling service that resides on computing device 202A, or which computing device 202A interacts with via a network (i.e., a cloud-based event scheduling service).

The event scheduling service may match the user-provided tag query to one or more linked events based on keyword and/or phrase matching, including synonym matching. In this example, the event scheduling application has determined that one set of linked events match the query input into tag query user interface element 206. That tag query is therefore displayed on computing device 202B (which may be the same or a different computing device as computing device 202A) in matched tag query user interface element 206 in association with information related to the set of linked events that were determined to match the tag query.

In this example, the displayed information related to the set of linked events that were determined to match the tag query includes the calendar dates corresponding to each of the linked events that are related to the tag query (January 10 [212], February 7 [214], March 7 [216], and one or more additional calendar dates N [218]). In examples, the displayed information may include additional content related to the set of linked calendar events. In this particular example, user interface element 220 provides a total number of the linked calendar events that match the tag query (i.e., 7 meetings), user interface element 226 provides a list of users that attended and/or were invited to each of the linked meetings (i.e., Charles Lee, Warren Johnson, Tracy Western, Tristan Barnes, Jonathan Carrier), user interface element 222 provides an average meeting time for the set of linked calendar events (i.e., 45 minutes), and user interface element 224 provides a selectable option to have a digital assistant utilize information, from the set of linked calendar events, to automatically schedule the next calendar event in the set of linked calendar events.

If a user selects “Yes” in user interface element 224 (i.e., the user would like the digital assistant to automatically schedule the next calendar event in the set of linked calendar events), the digital assistant may analyze information related to each of the set of linked calendar events, and use that information to intelligently create/send out an event request for the next calendar event in the set. For example, if each of the linked calendar events takes place on a same day of the week and/or a same time, the digital assistant service may attempt to schedule the next calendar event in the set for the same day of the week and/or time of day. Similarly, if each of the linked calendar events includes the same group of invitees/attendees, the digital assistant service may invite each of those users to the next event in the set. The digital assistant service may also generate a title of the next event from information that was provided in one or more of the previous calendar events, include attachments and/or content in the body of the invite that was included in one or more of the previous calendar event invites, and/or schedule the next event in the set for a same or similar duration as one or more of the previous calendar events.

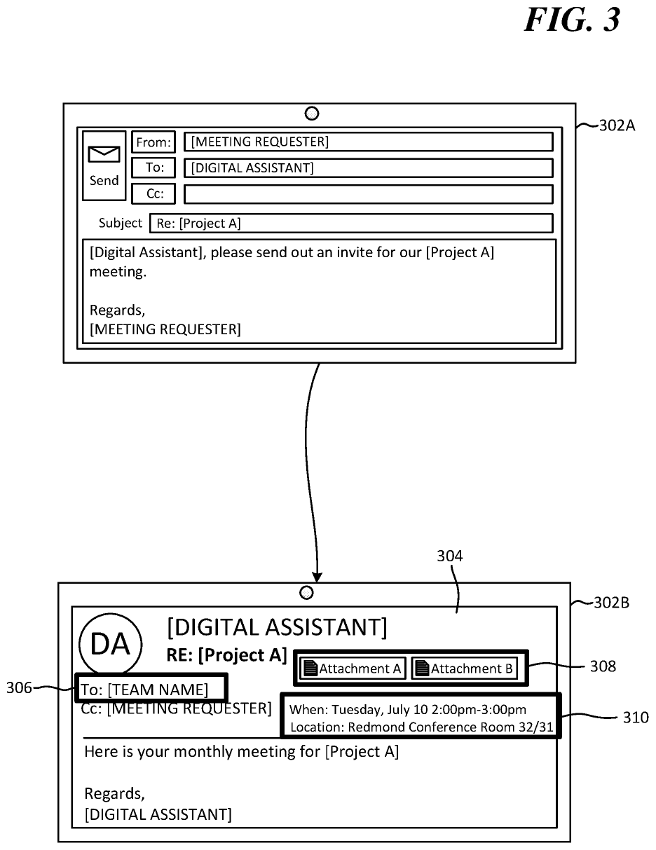

FIG. 3 illustrates a digital assistant utilizing information from a set of automatically associated calendar events to send out a calendar invite for the next event in the set. Computing device 302A displays an email that the user “meeting requester” has composed to a digital assistant, which the digital assistant will utilize to schedule a calendar event. The subject in the email is “Project A”, and the body of the email provides: “[Digital Assistant], please send out an invite for our [Project A] meeting. Regards, [Meeting Requester].” In determining which users to send a meeting invite to, what to include in the meeting invite, what time to schedule the invite for, what date to schedule the invite for, whether attachments should be included with the invite, and if attachments are to be included, which ones, the digital assistant may interact with an event scheduling service.

The digital assistant may provide a query to the digital assistant service that is matched to one or more linked calendar event tags in one or more searchable indices. For example, the digital assistant may utilize the subject line in the email sent from the meeting requester to determine whether a set of linked events correspond to the email, and/or the digital assistant may match the name of the sending requester to one or more previous meeting invites that the sending requester sent out to determine how to handle the current request. Once a set of linked calendar events are identified as a match, the digital assistant may identify shared properties amongst those linked calendar events, which the digital assistant can use to generate the new meeting request.

Computing device 302B displays a meeting invite 304 that the digital assistant service has sent in response to the email message sent from the meeting requester. In this example, the “to” field in meeting invite 304 has been populated by the digital assistant with “[Team Name],” which is the alias for a set of user email addresses that the digital assistant has sent the meeting invite to. The users corresponding to [Team Name] may have been identified from one or more linked calendar events that included those same or similar users. The digital assistant has also included attachment A and attachment B with the meeting invite, as is shown at display element 308 in meeting invite 304. Attachments A and B may have been included in the one or more linked calendar events that the digital assistant identified in generating meeting invite 304. For example, Attachment A may comprise a meeting agenda that was attached to one or more of the linked calendar events, and Attachment B may comprise a status report that was attached to one or more of the linked calendar events. Meeting invite 304 also includes an event time and date (2 pm-3 pm on Tuesday July 10) and a Location (Redmond Conference Room 32/31). The digital assistant may have selected the event time, date and location based on information associated with one or more of the linked calendar events that it identified.

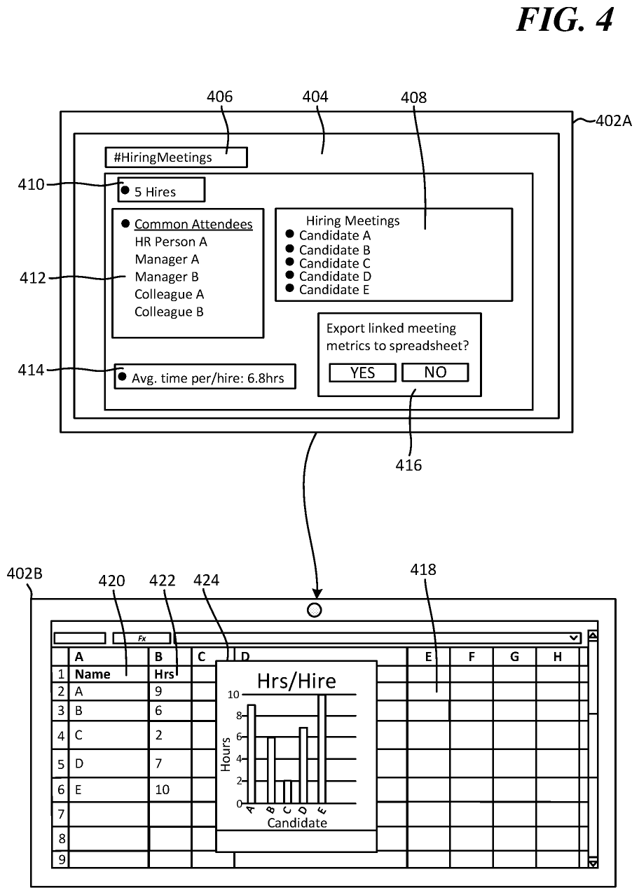

FIG. 4 illustrates exemplary user interface elements for interacting with metrics generated from automatically linked calendar events. FIG. 4 includes computing device 402A with a first set of properties displayed on user interface 404 that are associated with a linked set of calendar events corresponding to the “# HiringMeetings” tag 406, and computing device 402B (which may be the same or a different computing device as computing device 402A), which displays an exported version of exemplary metrics which can be extracted from the set of linked calendar events corresponding to the “# HiringMeetings” tag 406.

The event scheduling service may identify one or more properties from the set of linked events corresponding to the “# HiringMeetings” tag 406, and displayably present them on user interface 404. In this example, the event scheduling service has identified from content associated with the linked events corresponding to the “# HiringMeetings” tag 406 that: there were five new employees hired as a result of meetings that took place in the set of linked events corresponding to the “# HiringMeetings” tag 406, as indicated at user interface element 410; there were five attendees that each attended a majority and/or each of the meetings (i.e., HR person A, Manager A, Manager B, Colleague A, Colleague B), as indicated at user interface element 412; the five employees that were hired (and that were the subject of the meetings) were Candidate A, Candidate B, Candidate C, Candidate D, and Candidate E, as indicated at user interface element 408; and the average amount of time spent in meetings by interviewers prior to hiring a candidate was 6.8 hours, as indicated at user interface element 414. User interface 404 also includes a selectable element 416 for exporting linked meeting metrics to a spreadsheet.

Computing device 402A displays exemplary exported linked meeting metrics on spreadsheet 418. Specifically, information corresponding to an amount of meeting time that was spent in relation to hiring each of candidates A-E has been identified from the linked meetings, and provided in column A 420 (the name of each candidate), and column B 422 (the number of hours spent in meetings before hiring a corresponding candidate). The name and hour information extracted from the linked meetings has also been used to generate table 424, which displays each hired candidate in relation to the number of hours in meetings that were spent prior to each candidate being hired. Other metrics may be identified from linked calendar events and similarly provided via user interface elements such as those shown in relation to FIG. 4.

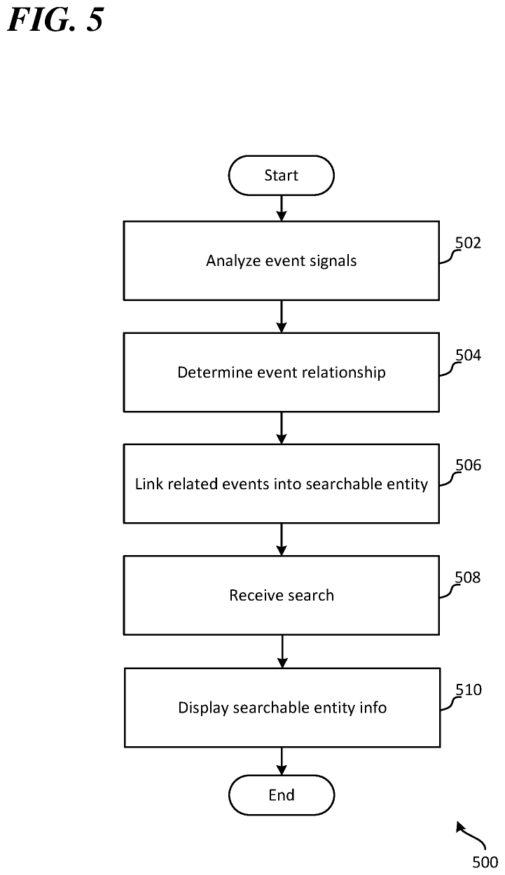

FIG. 5 is an exemplary method 500 for assisting with related calendar events. The method 500 begins at a start operation and flow continues to operation 502 where one or more signals associated with a plurality of calendar events are analyzed. In some examples, the one or more calendar events and their corresponding signals may be stored in association with an event scheduling service. The event scheduling service may analyze the signals, a digital assistant may analyze the signals, and/or a user's computing device that is associated with one or more of the calendar events may analyze the signals. The analysis is performed to identify whether one or more calendar events relate to common subject matter and/or a common theme. In some examples, there may be calendar events that are determined to belong to groups and sub-groups therein based on one or more event signals and/or event invitation signals. For example, a set of calendar events may be determined to relate to a main group “hiring”, a first sub-group “accounting” for the department of the enterprise that is doing the hiring, and a second sub-group “candidate A” which includes all meetings that took place related to hiring candidate A in the accounting group. In some examples, the analysis may comprise determining whether one or more overlapping tags should associated with one or more calendar events. For example, if a plurality of calendar events are determined to have two common signals (e.g., each event in the set has a same subject in the invite, and each event in the set has a same attachment in the invite), each of those calendar events may be tagged with one or more keywords or phrases corresponding to the same subject and/or the same attachment name or content in the attachment. The signals that are analyzed to determine whether the one or more calendar events are related, may comprise one or more of: content in one or more electronic message event invitations associated with calendar events; identities of invitees associated with calendar events; content in one or more subject lines in electronic message invites of calendar events; a location where calendar events are scheduled to take place; a type of communication associated with calendar events; a duration of calendar events; a day in a week when calendar events are scheduled to take place; and a time in a day when calendar events are scheduled to take place.

From operation 502 flow continues to operation 504 where a determination is made, based on the analysis performed at operation 502, that the plurality of calendar events are related. In some examples, one or more machine learning models may be applied to one or more of the above-described signals to determine whether events should be linked. The machine learning models may be trained with user interaction (e.g., users may verify that the event scheduling service has appropriately linked events and/or inappropriately linked events). For example, if a first machine learning model has been applied to a plurality of events that are then linked by the event scheduling service, but users have manually indicated that those links were inappropriately created, that machine learning model may be indicated as not performing well, and thus it may be modified or applied to other event types. In another example, if a second machine learning model has been applied to a plurality of events that are then linked by the event scheduling service, and users have manually indicated that those links have been appropriately created, that machine learning model may be indicated as performing sufficiently, and it may be applied more frequently and/or to similar types of event data. In other examples, a determination that the plurality of calendar events are related may be made based on one or more values associated with one or more event signals and/or event invitation signals.

From operation 504 flow continues to operation 506 where the plurality of calendar events are linked into a searchable entity with grouped properties. In some examples, the linking of the searchable entities may comprise applying one or more searchable tags associated with one or more properties of the linked calendar events and/or one or more searchable tags associated with one or more topical categories that one or more of the calendar events has been classified into. In some examples, the tags may be associated with one or more searchable indices. The grouped properties may comprise common content in the body of calendar invites, common content in the title of calendar invites, common content in the subject of calendar invites, common invitees, common senders, common dates, common times, and/or other overlapping calendar event signals amongst one or more calendar events.

From operation 506 flow continues to operation 508 where a search that indicates at least one of the grouped properties is received. The search may comprise a keyword or phrase that corresponds to one or more of the grouped properties, a keyword or phrase that corresponds to one or more tags that have been applied to one or more of the calendar events, and/or synonyms of the same.

From operation 508 flow continues to operation 510 where information associated with the searchable entity is caused to be displayed. In some examples, the information may comprise one or more calendar dates and events corresponding to the linked calendar events. In additional examples, the information may comprise metrics and/or analytics corresponding to one or more of the linked calendar events (e.g., total number of events in a linked group or sub-group, total amount of invitee time spent in meetings associated with a linked group or sub-group, identity of common properties amongst a linked group or sub-group). In some examples, the information may be drilled down into for more detailed information and/or compared to metrics from other linked calendar events (e.g., compare the number of calendar event hours spent to complete Project A with the number of calendar event hours spent to complete Project B; identify the cost of management hours spent in hiring meetings for candidates in one group in an enterprise compared with the cost of management hours spent in hiring meetings for candidates in a second group in the enterprise).

From operation 510 flow continues to an end operation, and the method 500 ends.

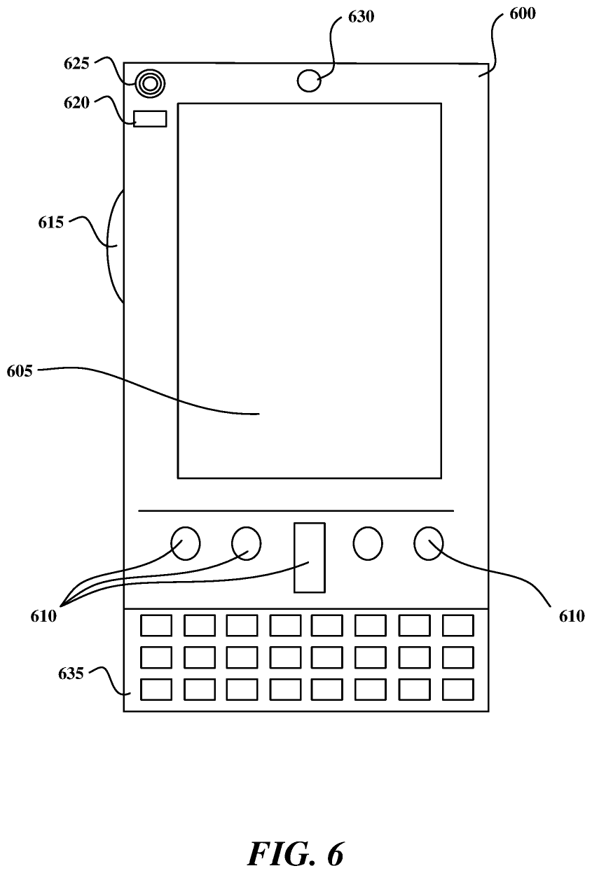

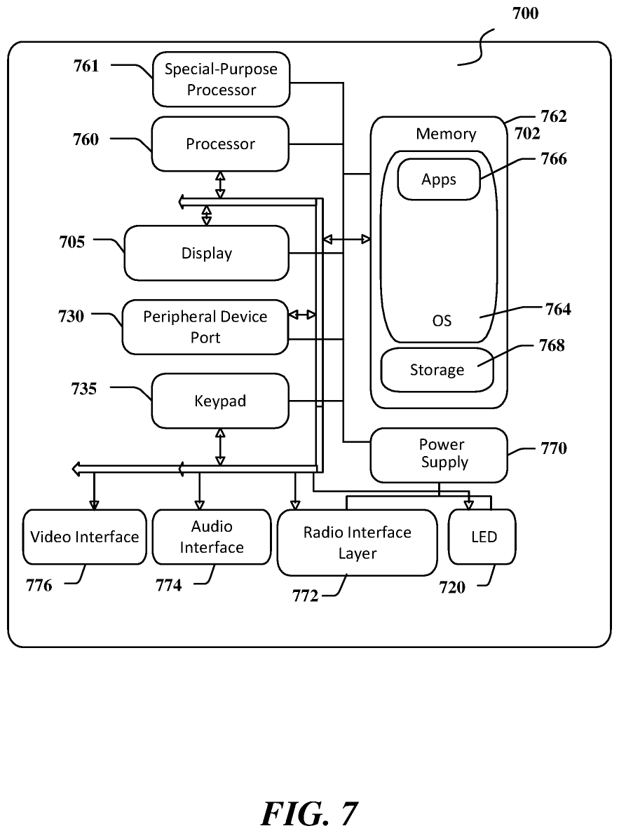

FIGS. 6 and 7 illustrate a mobile computing device 600, for example, a mobile telephone, a smart phone, wearable computer (such as smart eyeglasses), a tablet computer, an e-reader, a laptop computer, or other AR compatible computing device, with which embodiments of the disclosure may be practiced. With reference to FIG. 6, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative aspects, mobile computing device 600 may incorporate more or fewer input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 7 is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 864. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including instructions for providing and operating a digital assistant computing platform.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 620 may be used to provide visual notifications, and/or an audio interface 774 may be used for producing audible notifications via the audio transducer 625. In the illustrated embodiment, the visual indicator 620 is a light emitting diode (LED) and the audio transducer 625 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 625, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 630 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7 by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

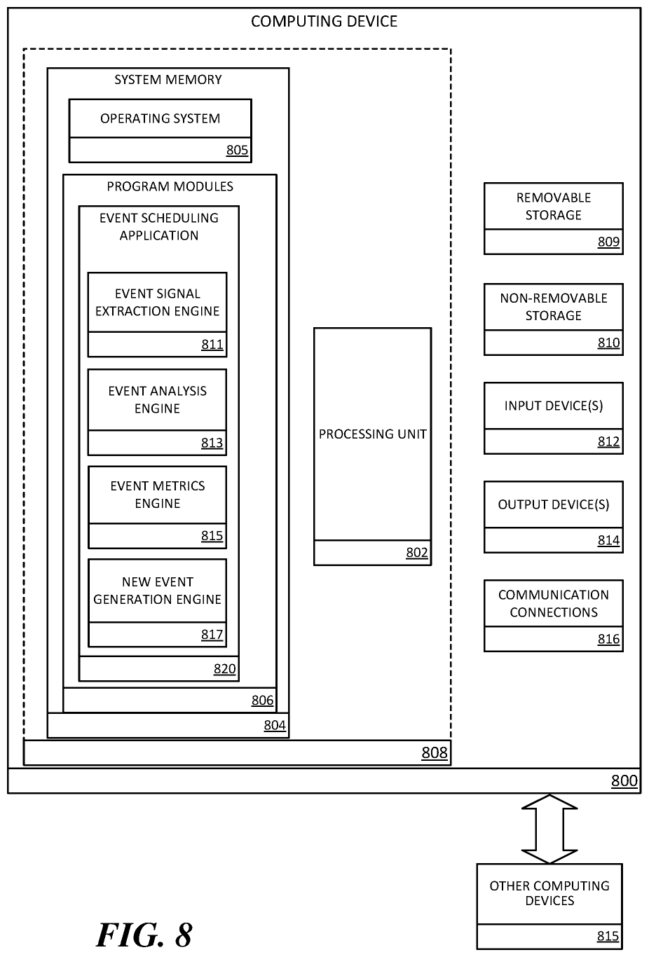

FIG. 8 is a block diagram illustrating physical components (e.g., hardware) of a computing device 800 with which aspects of the disclosure may be practiced. The computing device components described below may have computer executable instructions for assisting with association of related calendar events. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805 suitable for running one or more digital assistant programs. The operating system 805, for example, may be suitable for controlling the operation of the computing device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 (e.g., event scheduling application 820) may perform processes including, but not limited to, the aspects, as described herein. According to examples, the event signal extraction engine 811 may perform one or more operations associated with identifying one or more signals associated with events and/or event invitations. The event analysis engine 813 may perform one or more operations associated with determining whether one or more events are associated with one another based on analysis of one or more shared signals. The event analysis engine 813 may make the determination based on application of one or more machine learning models and/or values associated with one or more signals. Event metrics engine 815 may perform one or more operations associated with generating displayable metrics associated with one or more linked sets of events. New event generation engine 817 may perform one or more operations associated with automatically scheduling a next event in a linked set of events (e.g., automatically sending out an event invitation and related content for a next event in a chain of events).

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 850. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

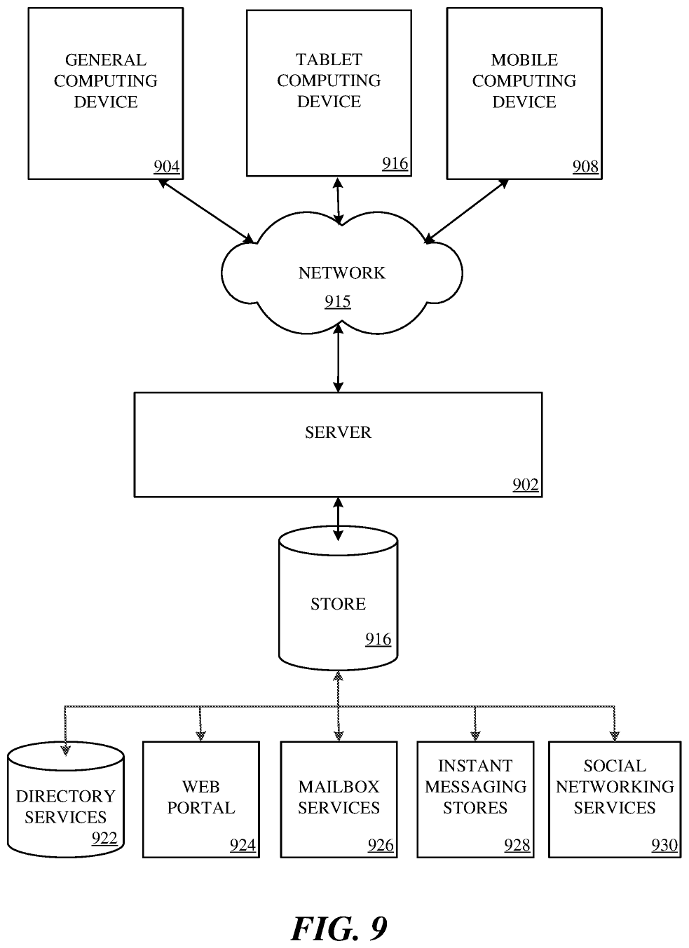

FIG. 9 illustrates one aspect of the architecture of a system for processing data received at a computing system from a remote source, such as a personal/general computer 904, tablet computing device 906, or mobile computing device 908, as described above. Content displayed at server device 902 may be stored in different communication channels or other storage types. For example, various documents may be stored using a directory service 922, a web portal 924, a mailbox service 926, an instant messaging store 928, or a social networking site 930. The program modules 806 may be employed by a client that communicates with server device 902, and/or the program modules 806 may be employed by server device 902. The server device 902 may provide data to and from a client computing device such as a personal/general computer 904, a tablet computing device 906 and/or a mobile computing device 908 (e.g., a smart phone) through a network 915. By way of example, the computer system described above with respect to FIGS. 6-8 may be embodied in a personal/general computer 904, a tablet computing device 906 and/or a mobile computing device 908 (e.g., a smart phone). Any of these embodiments of the computing devices may obtain content from the store 916, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The systems, methods, and devices described herein provide technical advantages for scheduling calendar events. By automatically linking calendar events by utilizing shared properties and signals, an event scheduling service can automatically: identify a next calendar event in a chain of events that should be scheduled; identify what information should be included in event invitations associated with that next calendar event; and identify which individuals to send the corresponding calendar event invitations to, thereby significantly decreasing computer processing costs associated with users having to execute contact list and calendar queries identify that information and/or sift through documents and other content that the users would like to include with the calendar event invitations. From a management standpoint, time and resources may also be saved via the mechanisms described herein. For example, utilizing metrics comprised of related event chains that are associated with similar tasks, managers may make determinations regarding efficient work flow (e.g., which individuals are key to making certain decisions, how much meeting time is generally necessary to accomplish certain tasks). Utilizing the systems, methods, and devices described herein, processing and storage costs may also be reduced through digital assistant leveraging of linked calendar event relationships and properties. Digital assistants may identify information that should be included with event invitations (e.g., attachments, information in the body of an invite, information in the subject line of an invite), and identify appropriate times, locations, and communication types for events to take place, thereby significantly reducing the amount of computing resources that would otherwise be required in the back-and-forth amongst event attendees in identifying and agreeing on that information.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method for assisting with related calendar events, the method comprising:
analyzing one or more signals associated with a plurality of calendar events;
determining, based on the analysis, that the plurality of calendar events are related;
linking the plurality of calendar events into a searchable entity with grouped properties;
receiving a search that indicates at least one of the grouped properties; and
causing information associated with the searchable entity to be displayed.

2. The method of claim 1, wherein a digital assistant automatically performs the analysis of the one or more signals associated with the plurality of calendar events and links the plurality of calendar events into the searchable entity with one or more searchable tags.

3. The method of claim 1, further comprising:
receiving an indication to present analytics relating to one or more of the grouped properties; and
causing analytics related to the one or more grouped properties to be displayed.

4. The method of claim 3, wherein the one or more grouped properties comprise one or more of: an identity of one or more invitees to the plurality of calendar events; a duration of one or more of the plurality of calendar events; and an identity of a creating user of one or more of the plurality of calendar events.

5. The method of claim 1, wherein the displayed information associated with the searchable entity comprises analytics related to the one or more grouped properties.

6. The method of claim 5, wherein the one or more grouped properties comprise one or more of: an identity of one or more invitees to the plurality of calendar events; a duration of one or more of the plurality of calendar events; and identity of a creating user of one or more of the plurality of calendar events.

7. The method of claim 1, wherein linking the plurality of calendar events into a searchable entity with grouped properties comprises applying a topical classification tag to each of the plurality of calendar events.

8. The method of claim 1, wherein each of the plurality of calendar events is associated with completion of a task of a specific type, and wherein the method further comprises:
comparing data associated with the linked calendar events to data associated with another set of linked calendar events associated with another task of the specific type; and
causing analytics associated with the comparison to be displayed.

9. The method of claim 1, wherein the one or more signals associated with the plurality of calendar events comprise one or more of: content in one or more electronic message event invitations associated with the plurality of calendar events; identities of invitees associated with the plurality of calendar events; content in one or more subject lines in electronic message invites to the plurality of calendar events; a location where each of the plurality of calendar events is scheduled to take place; a type of communication associated with each of the plurality of calendar events; a duration of each of the plurality of calendar events; a day in a week when each of the plurality of calendar events is scheduled to take place; and a time in a day when each of the plurality of calendar events is scheduled to take place.

10. A system for assisting with related calendar events, comprising:
a memory for storing executable program code; and
one or more processors, functionally coupled to the memory, the one or more processors being responsive to computer-executable instructions contained in the program code and operative to:
analyze one or more signals associated with a plurality of calendar events;
determine, based on the analysis, that the plurality of calendar events are related;
link the plurality of calendar events into a searchable entity with grouped properties;
receive a search that indicates at least one of the grouped properties; and
cause information associated with the searchable entity to be displayed.

11. The system of claim 10, wherein a digital assistant automatically performs the analysis of the one or more signals associated with the plurality of calendar events and links the plurality of calendar events into the searchable entity with one or more searchable tags.

12. The system of claim 10, wherein the one or more processors are further responsive to the computer-executable instructions contained in the program code and operative to:
receive an indication to present analytics relating to one or more of the grouped properties; and
cause analytics related to the one or more grouped properties to be displayed.

13. The system of claim 12, wherein the one or more grouped properties comprise one or more of: an identity of one or more invitees to the plurality of calendar events; a duration of one or more of the plurality of calendar events; and an identity of a creating user of one or more of the plurality of calendar events.

14. The system of claim 10, wherein linking the plurality of calendar events into a searchable entity with grouped properties comprises applying a topical classification tag to each of the plurality of calendar events.

15. The system of claim 10, wherein each of the plurality of calendar events is associated with completion of a task of a specific type, and wherein the one or more processors are further responsive to the computer-executable instructions contained in the program code and operative to:
compare data associated with the linked calendar events to data associated with another set of linked calendar events associated with another task of the specific type; and
cause analytics associated with the comparison to be displayed.

16. A computer-readable storage device comprising executable instructions that, when executed by one or more processors, assists with related calendar events, the computer-readable storage device including instructions executable by the one or more processors for:
analyzing one or more signals associated with a plurality of calendar events;
determining, based on the analysis, that the plurality of calendar events are related;
linking the plurality of calendar events into a searchable entity with grouped properties;
receiving a search that indicates at least one of the grouped properties; and
causing information associated with the searchable entity to be displayed.

17. The computer-readable storage device of claim 16, wherein a digital assistant automatically performs the analysis of the one or more signals associated with the plurality of calendar events and links the plurality of calendar events into the searchable entity with one or more searchable tags.

18. The computer-readable storage device of claim 16, wherein the instructions are further executable by the one or more processors for:
receiving an indication to present analytics relating to one or more of the grouped properties; and
causing analytics related to the one or more grouped properties to be displayed.

19. The computer-readable storage device of claim 18, wherein the one or more grouped properties comprise one or more of: an identity of one or more invitees to the plurality of calendar events; a duration of one or more of the plurality of calendar events; and an identity of a creating user of one or more of the plurality of calendar events.

20. The computer-readable storage device of claim 16, wherein each of the plurality of calendar events is associated with completion of a task of a specific type, and wherein the instructions are further executable by the one or more processors for:
comparing data associated with the linked calendar events to data associated with another set of linked calendar events associated with another task of the specific type; and
causing analytics associated with the comparison to be displayed.
